(19) United States
(12) Patent Application Publication
(10) Pub. No.: US 2009/0088058 A1
(43) Pub. Date: Apr. 2, 2009

(54) DRIVING OF A SPLITTING TOOL HOLDER FOR AN ANIMAL CARCASS SPLITTING MACHINE

(75) Inventor: Nicolas Klein, Loriol Sur Drome (FR)

Correspondence Address: HARNESS, DICKEY & PIERCE, P.L.C., P.O. BOX 828, BLOOMFIELD HILLS, MI, 48303, US

(73) Assignee: Durand International, Baix (FR)

(21) Appl. No.: 12/239,903

(22) Filed: Sep. 29, 2008

(30) Foreign Application Priority Data
Sep. 28, 2007 (FR) 0706805

(51) Int. Cl. A22B 5/20; A22B 5/00

(52) U.S. Cl. 452/153; 452/152

(57) ABSTRACT

The invention relates to a device for driving a splitting tool holder intended for an animal carcass splitting machine including a main carriage having sliding guide means for a splitting tool holder; a splitting tool holder supporting a splitting tool; means for driving the splitting tool in order to make it operational; operation programming means; means for slidingly driving the tool holder carried by the main carriage and connected to the tool holder and means for controlling said driving means, characterised on the one hand, by electric driving means which can be stopped in one or several adjustable precise known positions considered as reference positions for the splitting tool; on the other hand, in that the control means are able to control not only the operation and stoppage of the electric driving means but also the adjustment in position thereof, in order to adjust the reference position of the splitting tool according to the needs; the reference positions for the splitting tool being selected among the following: initial retracted position, initial splitting position, final splitting position, final retracted position.

### CROSS-REFERENCE TO RELATED APPLICATIONS

This application claims priority to French Application No. 0706805, filed Sep. 28, 2007, which is incorporated by reference herein.

### BACKGROUND AND SUMMARY

The invention relates to the driving of a splitting tool holder of an animal carcass splitting machine. It more particularly concerns on the one hand a device for driving a splitting tool holder, more particularly intended for an animal carcass splitting machine, on the other hand, an animal carcass splitting machine including such driving device. The invention more particularly relates to pig carcasses and to carcasses of other animals of the same type.

Machines for splitting animal carcasses, i.e. pigs, are already known, which include:
a main carriage, forming a movable frame, having sliding guide means for a splitting tool holder,
a splitting tool holder supporting a movable splitting tool, said splitting tool holder being slidingly movable on the main carriage between a retracted position and an initial splitting position where the distal end of the splitting tool is able to interfere with a carcass positioned to be processed by the machine,
a device for driving the splitting tool holder and thus the splitting tool itself,
means for driving the splitting tool in order to make it operational,
and means for programming the operation of the machine.
   Conventionally, the device for driving the splitting tool holder includes a pneumatic jack providing the motion between two fixed end positions i.e. a totally folded position and a totally unfolded position. The sliding stroke between such two end positions is determined by mechanical stops (or protrusions) arranged on the main carriage and the splitting tool holder.

In another known way, such a machine further includes a front supporting device and/or a back supporting device, which is movable and/or deformable, able to rest on the carcass processed by the machine on the front side and/or the back side, respectively. The front supporting device is positioned on the same side as the splitting tool holder and the splitting tool. The back supporting device is positioned on the side opposite the splitting tool holder and the splitting tool. More precisely, the front supporting device and/or the back supporting device is carried by the main carriage, i.e. the splitting tool holder.

Besides, in another way, the splitting tool holder includes sliding means and motion driving and/or dumping means for the front supporting device (possibly the back supporting device), which is carried by the splitting tool holder in a sliding way along a to and fro direction. Means supporting the animal carcasses to be processed are associated with such a machine and arranged to provide the running of carcasses to be processed in the machine.

According to the embodiments, the splitting tool is either one or an assembly of knives (FR-A-2535944) or a circular saw blade driven in rotation (U.S. Pat. No. 5,655,960, EP-A-1125502) by suitable driving means. According to the embodiments, the machine includes either one assembly positioned on one side of the means supporting the animal carcasses to be processed (U.S. Pat. No. 5,655,960), or two assemblies positioned on either side of such supporting means (FR-A-2535944, EP-A-1125502). In this later case, a first assembly includes the main carriage, the splitting tool holder, the splitting tool and the front supporting device, whereas a second assembly includes the back supporting device.

According to one embodiment (EP-A-112550219), the first assembly includes a first column supporting the main carriage, the splitting tool holder, the splitting tool and the front supporting device, whereas the second assembly includes a second column supporting the back supporting device, the first column and the second column forming a single package assembly. With such a machine, in the various configurations it may have, the operation programming means are programmed so that during the operation and whereas a carcass is in a position to be processed by the machine:
the splitting tool holder is brought to the splitting initial position desired,
and the carcass is positioned through the implementation of the front supporting device and the back supporting device.
   Then, of course, the splitting tool is operated. According to the embodiments, the machine is programmed to provide either a complete splitting of the carcass into carcass halves or a partial splitting while leaving an unsplit strip of skin at the back and towards the head (this cut is known as the “American cut”).

In the case where the splitting tool is a circular saw blade, the latter wears when and as it is operated and must be sharpened from time to time. The result is that the diameter of the saw blade diminishes over time, which is a problem. As a matter of fact, whereas with a new saw blade, a distal end of the saw blade may be placed in a position determined for an optimum splitting, when and as the saw blade gets worn, the distal end thereof gets further and further—backwards—from such optimum position. This is the reason why the machine may be used under conditions which are not really optimum—which involves the inherent consequences on the quality of the splitting carried out—or if the same splitting quality is aimed at, the machine must be adjusted while acting on the mechanical limit stops for the sliding of the splitting tool holder, as suggested in the document U.S. Pat. No. 4,653,150. Such an adjusting operation which aims at slidingly moving the splitting tool holder, is difficult to carry out and takes time, which reduces the machine output.

The same problem occurs when the characteristics of the carcasses processed vary over time. So far, carcass splitting machine is operated at least in a series of operation cycles with identical carcasses as regards the type of animal, for example pigs, and analog carcasses as regards their characteristics more particularly the shape and the size thereof. In spite of this, the relative position between the distal end of the saw blade and the carcass is not perfectly constant because of the—even slight—variations in the shape and the size of the successive carcasses processed by the machine.

The invention aims at solving these various problems with a solution of a simple and robust construction and easily operated. For this purpose and according to a first aspect, the invention relates to a device for driving a splitting tool holder, more particularly intended for a machine splitting animal carcasses, and more particularly pigs, said machine including:
a main carriage forming a frame having sliding guide means for a splitting tool holder,
a splitting tool holder supporting a movable splitting tool, said splitting tool holder being slidingly movable on the main carriage along a to and fro direction; when the splitting tool holder is in the initial position, said splitting tool holder being slidingly movable on the main carriage between a retracted position and an initial splitting position where the distal end of the splitting tool is able to interfere with the carcass C processed by the machine; when the splitting tool holder is in the final position, the splitting tool holder being slidingly movable on the main carriage between a final splitting position and a retracted position where the splitting tool is able not to interfere with the carcass C,
means for driving the splitting tool in order to make it operational,
and means for programming the operation,
   said device including slidingly driving means for the splitting tool holder, carried by the main carriage and connected to the splitting tool holder, and means for controlling said driving means,
   characterised:
on the one hand, by electric driving means which can be stopped in one or several adjustable accurate and known position or positions considered as reference positions for the splitting tool,
on the other hand, in that the control means are able to control not only the operation and the stoppage of the electric driving means, but also their adjustment in the correct position, in order to adjust the reference position of the splitting tool as requested.

The reference positions for the splitting tool are selected among the following positions: initial retracted position, initial splitting position, final splitting position, final retracted position. More particularly, the initial splitting position is related with the wear intensity of the splitting tool, in this case a circular saw blade.

According to one embodiment which the driving device is particularly well adapted to, the splitting tool is a circular saw blade rotatingly mounted in operation. According to another embodiment, the splitting tool is a knife or a set of knives. According to one embodiment, the electric driving means include a motor or a gear motor carried by the main carriage driving a movable member which the splitting tool holder is kinetically connected to. According to a particularly advantageous embodiment, the motor or the gear motor is of the brushless type. According to various possible embodiments, the movable member kinetically connected to the splitting tool holder is an endless belt, a link or a cable, a rack or a screw.

According to one embodiment, the control means are responsive to a manual control or to a signal from a programmable automatic machine or presence or distance estimation means. More particularly and as regards the wear intensity of the circular saw blade mentioned above, the control means are more particularly responsive to the wear intensity of the saw blade and thus to the diameter thereof, so that the initial sawing position of the saw blade remains constant whatever the wear intensity of the blade. In this case, the wear intensity is visually determined—either by a human being or by a suitable equipment—or according to the machine programming means, for example depending on the number of cycles accomplished.

According to another embodiment, in relation with the problem of varying animal types processed by the machine (pigs, piglets or a calf for example), the control means are responsive to the type and/or the characteristics of the carcass. Eventually, the control means may be responsive to the type of splitting to be carried out (complete cut or American cut), and/or at least a pre-programmed control of the means for programming the machine operation, depending on the production requests.

According to a second aspect, the invention consists of a machine for splitting animal carcasses, more particularly pigs, including:
a main carriage forming a movable frame, having sliding guide means for a splitting tool holder,
a splitting tool holder supporting a movable splitting tool, said splitting tool holder being slidingly movable on the main carriage between the retracted position and an initial splitting position where the distal end of the splitting tool is able to interfere with the carcass positioned to be processed by the machine,
means for driving the splitting tool in order to make it operational,
and means for programming the operation,
   such machine being characterised in that it includes means for driving the splitting tool holder as described above.
   According to one embodiment, the machine also includes a front supporting device and/or a back supporting device, which may be movable and/or deformable, able to rest on the carcass processed by the machine on the front side and/or the back side respectively, the front supporting device being positioned on the same side as the splitting tool holder and the splitting tool, the back supporting device being positioned on the side opposite the splitting tool holder and the splitting tool.

In this case and according to one embodiment, the front supporting device and/or the back supporting device is carried by the main carriage, and more particularly by the splitting tool holder. For this purpose, the splitting tool holder includes sliding means and driving means and/or means for dumping the motion of the front supporting device and/or the back supporting device, carried by the splitting tool holder in a sliding way and along a to and fro direction. According to the embodiments, the means for programming the machine operation are programmed either for a complete splitting of the carcass into two carcass halves or for a partial splitting of the American cut type.

According to one embodiment, means for supporting the animal carcasses to be processed are associated with the machine and arranged to provide the running of the carcasses to be processed in the machine. According to the embodiments, the machine is made with either only one assembly positioned on one side of the means supporting the animal carcasses to be processed or in two assemblies positioned on either side of such supporting means. In the latter case, a first assembly includes the main carriage, the splitting tool holder, the splitting tool and the front supporting device, whereas a second assembly includes the back supporting device. According to one embodiment, the first assembly includes a first column supporting the main carriage, the splitting tool holder, the splitting tool and the front supporting device and the second assembly includes a second column supporting the back supporting device. In this case and according to one embodiment, the first column and the second column form a single package assembly.

With an animal carcass splitting machine as has just been described, the machine operation programming means are programmed so that in operation and when a carcass is in a position to be processed by the machine:
the splitting tool holder is brought to the initial splitting position desired,
and the carcass to be processed is brought in position through a combined implementation on either side of the carcass of the back supporting device and the front supporting device, said combined implementation being based on an action/reaction effect between the air pressures of the chambers of the jacks of the back supporting device and the front supporting device. Then, the splitting tool is operated. In the case where the operation programming means are programmed for a partial splitting of the American cut type, the front supporting device slides to the side where the back supporting device is positioned, while maintaining said combined implementation of the back supporting device.

### BRIEF DESCRIPTION OF THE DRAWINGS

Several embodiments of the invention will now be described, while referring to appended drawings, wherein:

FIGS. 1A and 1B particularly illustrate on one side a machine for splitting pig carcasses, in one embodiment where the machine is composed of two assemblies on either side of the means supporting the carcasses to be processed, one where the splitting tool—here a saw blade—is found, and the front supporting device, the other in a position where the back supporting device is positioned. The saw blade, which is new or not worn in the case of FIG. 1A, has an original nominal diameter D. It has a certain wear intensity with a reduced diameter d with respect to the value in the case of FIG. 1B.

FIG. 2 illustrates on one side a possible embodiment of the driving system according to the invention, in one embodiment where the machine is made of two assemblies, with the splitting tool holder supporting the front supporting device, whereas the back supporting device is carried by an opposite distinct carriage. In this figure, the carriage carrying the saw blade is in a frontward position.

FIG. 3 is a perspective view, from the top, of the driving device of FIG. 2.

FIG. 4 is a partial and exploded perspective view, from the bottom, of the driving device of FIGS. 2 and 3.

### DETAILED DESCRIPTION

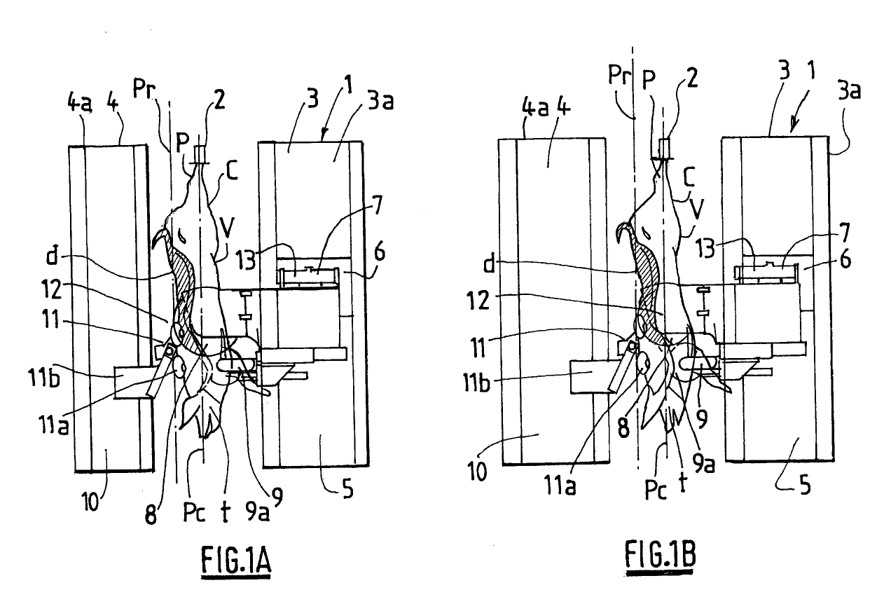

Now reference is made to FIGS. 1A and 1B which schematically illustrate a machine 1 for splitting carcasses C of animals, in this case pigs, having a head t, back legs p, a front side v and a back side d. The invention can be applied to the case of carcasses of animals similar to pigs—as regards the splitting to be carried out—for example calves.

Means supporting 2 carcasses C i.e. by the rear legs p, with the head t being oriented downwards, are associated with the machine 1. Such supporting means 2 include, for example, an endless conveying device extending horizontally and supporting, at more or less regular intervals, gambrels or hooks which the rear legs p are hanging from. Such supporting means 2 provide the running of carcasses C to be processed, horizontally and in a vertical plane Pc shown in the figures by a drawing thereof.

In the embodiment shown in FIGS. 1A and 1B, the machine 1 is made of two assemblies 3, 4 positioned on either side of the plane Pc, and thus of the supporting means 2. The first assembly 3 (positioned in FIGS. 1A and 1B on the right side of the supporting means 2) includes a first frame 3a and a first column 5 carried by the first frame 3a. The first column 5 supports a main carriage 6, a splitting tool holder 7, the splitting tool 8—in this case a saw blade—and a front supporting device 9. The splitting tool 8 may be a knife or a set of knives. The second assembly 4 (positioned on the figures on the left side of the support means 2) includes a second frame 4a and a second column 10 carried by the second frame 4a. The second column 10 supports a back supporting device 11.

In one embodiment, the first column 5 and the second column 10 form a generally U-shaped single package assembly, slidingly carried by a superstructure of the machine, on a horizontal stroke, parallel to the carcass running plane, along the means 2 supporting the carcasses C. Driving means are provided for this purpose. The general structure of such a machine is described in document EP-A-1 125 502 which reference can be made to. In another embodiment, the machine is made of only one assembly, positioned on one side of the plane Pc and thus of the supporting means 2. The general structure of such a machine is described for example in document U.S. Pat. No. 5,655,960 which reference can be made to.

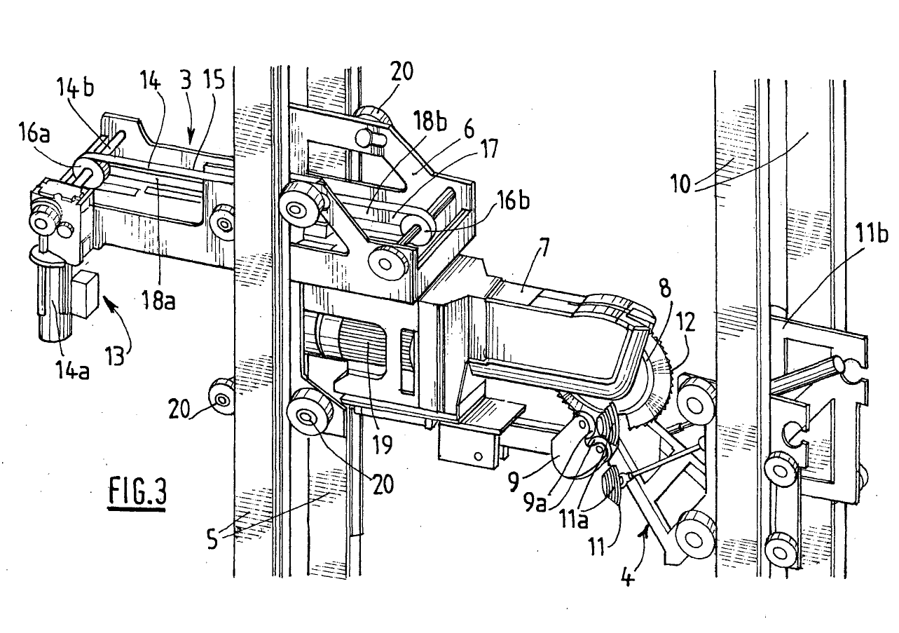

The main carriage 6 forms some kind of intermediate movable frame for the saw blade holder 7, the saw blade 8 and the front supporting device 9. The main carriage 6 is slidingly mounted on the first column 5, on a certain vertical stroke, through the sliding means—refer to the rollers 20 guiding the carriage 6 in FIG. 3—and suitable driving means. The main carriage 6 includes means 18a for slidingly guiding the saw blade holder 7 and provided with additional means 18b. Such guiding means 18a, 18b are arranged so that the saw blade holder 7 can slide horizontally, perpendicularly to the carcass running plane Pc. Such sliding motion extends either towards this plane (or in front or frontward) or in the direction opposite such plane (or backwards).

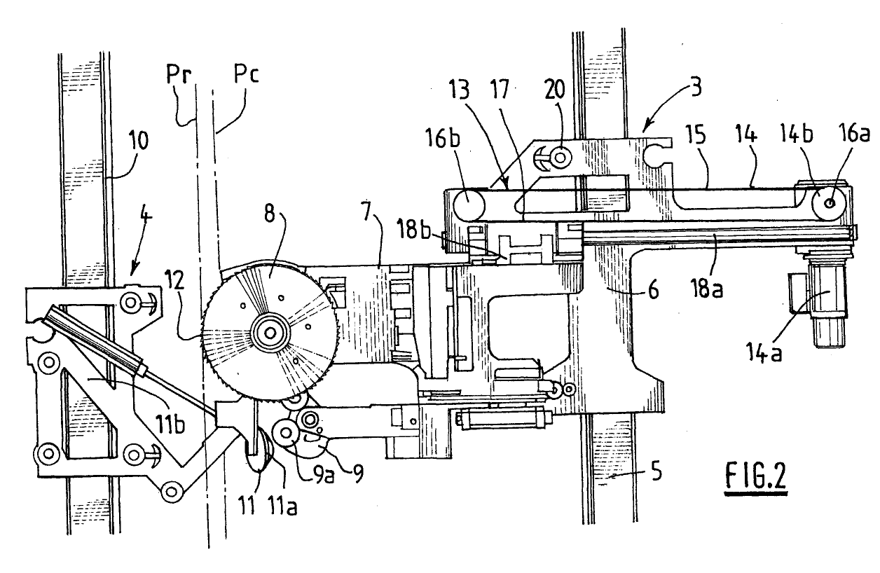

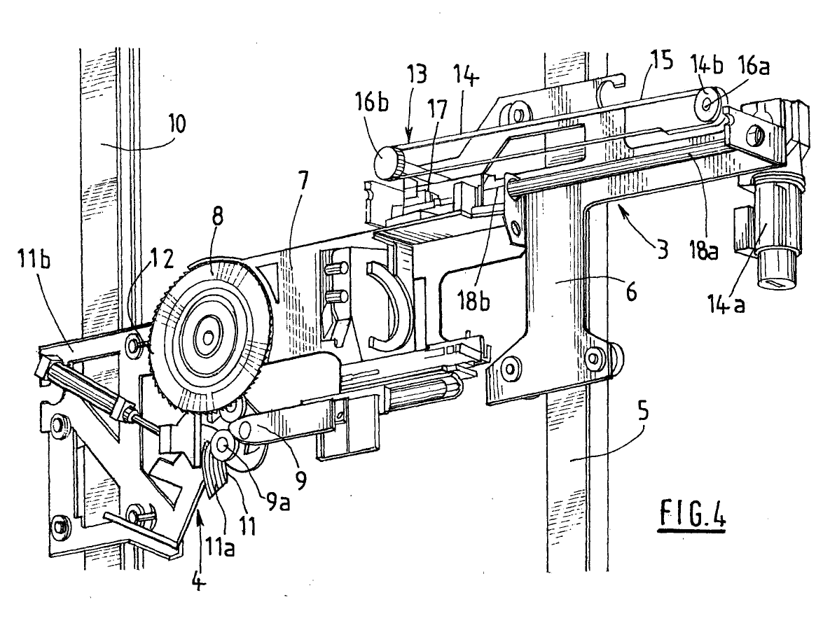

In one embodiment, the means 18a are of the guide rail type and means 18b are of the slider type. As can be seen in FIGS. 2 and 4, the means 18b of the slider type are positioned upwards and towards the back the blade holder 7, with the blade holder 7 being positioned frontward in a cantilevered position.

Therefor, the saw blade holder 7 is movable between a retracted position and an initial splitting position which corresponds to FIGS. 1A and 1B, wherein the distal end 12 of the saw blade 8 (the furthest from the first frame 3a) is able to interfere with a carcass C positioned to be processed by the machine. As shown in FIGS. 1A and 1B, such initial splitting position is defined by a reference vertical plane Pr. The plane Pr is parallel to the carcass running plane Pc. The plane Pr is shown in FIGS. 1A and 1B. The reference plane Pr is here positioned in FIGS. 1A and 1B on the left of the carcass running plane Pc i.e. it is positioned beyond the carcass running plane Pc with respect to the first assembly 3.

The main carriage 6 also supports means 19 for driving the splitting tool 8 in order to make it operational, in this case, a motor able to pivot the saw blade 8. Such means 19 are visible in FIG. 3 but they are not shown for reasons of clarity in the drawing of FIGS. 2 and 4. In this case, the motor 19 is positioned towards the back of the blade holder 7, underneath the slider type means 18b.

The front supporting device 9 and the back supporting device 11 are so arranged as to be movable and deformable. They are able to rest on the carcass C processed by the machine on the front side v and the back side d through rollers 9a, 11a. These devices 9, 11 are aimed at defining the precise positioning of the carcass C to be processed with respect to the position of the saw blade 8 so that the splitting or the sawing is carried out precisely at the desired location.

The front supporting device 4 is positioned on the same side as the saw blade holder 7 and the saw blade 8 whereas the back supporting device 11 is positioned on the side opposite the saw blade holder 7 and the saw blade 8. In fact, the front supporting device 9 is indirectly carried by the main carriage 6 and more precisely by the saw blade holder 7 which includes sliding means and means for driving and/or damping the motion of the front supporting device 9 along a to and fro direction. As for the back supporting device 11, it is carried by a carriage 11b slidingly mounted on the second column 10, on a vertical stroke through the sliding means and the driving means.

The machine 1 also includes a device 13 for driving the cutting blade holder 7 on the main carriage 6 along a to and fro direction, perpendicularly to planes Pc and Pr. The driving device 13 firstly includes sliding means 14 for driving the cutting blade holder 7, carried by the main carriage 6 and connected to the cutting blade holder 7. The driving device 13 includes secondly means for controlling the driving means 14. The machine 1 also includes means for programming its operation. The programming means are programmed either for a complete splitting of the carcass C in two carcass halves or for partial splitting of the American cut type.

The device 13 for driving the cutting blade holder 7 is such that, in the first place, the driving means 14 are electric driving means which can be stopped in a position corresponding to an adjustable precise and known initial splitting position, corresponding to the reference plane Pr. In the embodiment considered, the electric driving means 14 include a motor or a gear motor 14a carried by the main carriage 6 driving a shaft 14b where a toothed wheel 16a driving a movable member 15 is placed, wherein the saw blade holder 7 is kinetically connected. Typically, such motor or gear motor 14a is of the brushless type. The device 13 driving the cutting blade holder 7 is such that secondly the control means are able to control not only the operation and the stoppage of the electric driving means 14, but also the adjustment thereof in position, so as to adjust the initial splitting position of the saw blade according to the needs, i.e. whatever the wear intensity of the saw blade 8 which means that even though the diameter thereof is the initial nominal maximal diameter D (FIG. 1A) or a reduced diameter (FIG. 1B), its distal end 12 is in the reference plane Pr.

The movable member 15 kinetically connected to the saw blade holder 7 is, in the embodiment shown in FIGS. 2, 3 and 4, a belt positioned between the toothed wheel 16a and a tooth wheel 16b, the tooth wheel 16a being positioned towards the back of the main carriage 6 whereas the toothed wheel 16b is positioned towards the front of the carriage while being sufficiently distant from the toothed wheel 16a to allow the required sliding stroke, whereas the axles of the toothed wheels 16a, 16b are positioned horizontally and parallel to planes Pr and Pc. In other embodiments, the movable member 15 is an endless link or cable, a rack or an endless screw. The synchronous belt 15 is fixed to the saw blade holder 7 at an attachment point—or area—17.

Generally, the means controlling the driving device 13 are responsive to a manual control or to a signal from a programmable automatic machine or presence or distance estimation means integrated or functionally associated in/with the machine. As a matter of fact, the control means are responsive to the wear intensity of the saw blade 8 and thus to the diameter thereof so that the initial sawing position remains constant whatever the wear intensity of the blade. The wear intensity of the saw blade 8 is determined visually either—by a human being or by a suitable equipment such as a visual recognition, presence detection or distance measurement—or according to the machine programming means. For example, a certain theoretical diameter of the saw blade 8 is defined after a certain number of operation cycles of the machine 1. Thus, the operation may be more or less automatic.

In another embodiment, alone or combined with the previous one, the driving device 13 is such that the control means are responsive to the type and/or to the characteristics of the carcass and/or to the splitting type to be carried out (for example a complete splitting or an American cut), and/or to at least one previously programmed controlled of the means for programming the machine operation. For example, depending on the characterisation of the carcasses to be processed as “small carcass” or on the contrary, “big carcass”, the driving device 13 will act on the saw blade holder 7 in a more or less forward or backward position. With such a driving device 13, the members constituting the machine 1 have to fulfil new functions.

As a matter of fact, the means for programming the machine 1 operation are programmed so that in operation and while a carcass C is in the situation of being processed by the machine 1:
the saw blade holder 7 is brought to the sawing initial position desired,
then the carcass C to be processed through the combined implementation, on either side of the carcass C, of the back supporting device 11 and the front supporting device 9 is positioned.
   Then, the carcass C is sawn. The combined implementation of the devices 9, 11 is based on an action/reaction effect between the air pressures in the chambers of the jacks of the back supporting device 11 and the front supporting device 9.

If so required, the means for programming the machine 1 operation are programmed for a partial splitting of the American cut type. In this case and in order to leave an unsplit strip of skin in the back and at the bottom of the carcass C, the front supporting device 9 slides to the side where the back supporting device 11 is positioned, while maintaining the combined implementation of the back supporting device 11 and the front supporting device 9. The result is that the carcass C is pushed frontward which makes it escape from the saw blade.

The invention claimed is:

1. A device for driving a splitting tool holder, intended for a machine splitting carcasses of animals, said device comprising:
a main carriage forming a frame and having a sliding guide;
a splitting tool holder supporting a movable splitting tool, said splitting tool holder being slidingly movable on the main carriage along a to and fro direction with the assistance of the sliding guide;
the splitting tool holder being in the initial position, with said splitting tool holder slidingly moving on the main carriage between a retracted position and an initial splitting position where the distal end of the splitting tool is able to interfere with a carcass processed by the machine;
the splitting tool holder being in the final position, with said splitting tool holder being slidingly movable on the main carriage between a final splitting position and a retracted position where the splitting tool is able not to interfere with the carcass;
a driver operably driving the splitting tool in order to make it operational;
at least one member slidingly driving the splitting tool holder; and
a controller connected to the driver;
on the one hand, the controller can operably stop the driver and member in at least one of several adjustable positions considered as reference positions for the splitting tool; and
on the other hand, the controller can also operably adjust the driver and member at the reference position of the splitting tool as requested.

2. A device according to claim 1, wherein the reference position for the splitting tool is selected among the following positions: an initial retracted position, an initial splitting position, a final splitting position, and a final retracted position.

3. A device according to claim 1, wherein the driver includes a motor carried by the main carriage driving a movable member which the splitting tool holder is kinetically connected to.

4. A device according to claim 3, wherein that the motor is of a brushless type.

5. A device according to claim 1, wherein the at least one member is kinetically connected to the splitting tool holder and is at least one of: an endless belt, link, a cable, a rack, and an endless screw.

6. A device according to claim 1, wherein the controller is responsive to: a manual control, a signal from a programmable automatic machine, a presence estimator, and a distance estimator.

7. A device according to claim 1, wherein the splitting tool is at least one of: a rotatingly mounted circular saw blade, a knife, and a set of knives.

8. A device according to claim 1, wherein if the reference position for the splitting tool is the initial splitting position and the splitting tool is a saw blade, the controller is responsive to the wear intensity of the saw blade and thus to the diameter thereof, so that the initial sawing position of the saw blade remains constant whatever the wear intensity of the blade.

9. A device according to claim 8, wherein the wear intensity of the saw blade is visually determined.

10. A device according to claim 1, wherein the controller is responsive to at least one of the type of carcass, the characteristics of the carcass, the type of splitting to be carried out, and at least one previously programmed control of the machine.

11. A machine for splitting animal carcasses, the machine comprising:
a main carriage including a frame having a sliding guide;
a splitting tool holder supporting a movable carcass splitting tool, said splitting tool holder being slidingly movable on the main carriage between a retracted position and a splitting initial position;
a driver operating the splitting tool; and
at least one member moved by the driver to position the splitting tool to account for wear of the splitting tool, whether the wear be actually determined or estimated.

12. A machine for splitting animal carcasses according to claim 11, further comprising a front supporting device and a back supporting device which are movable to rest on the carcass processed by the machine, the front supporting device being positioned on the same side as the splitting tool holder and the splitting tool, the back supporting device being positioned on the side opposite the splitting tool holder and the splitting tool.

13. A machine for splitting animal carcasses according to claim 11, further comprising at least one of a front carcass supporting device and a back carcass supporting device carried by the main carriage.

14. A machine for splitting animal carcasses according to claim 11, further comprising at least one of a front carcass supporting device and a back carcass supporting device carried by the splitting tool holder.

15. A machine for splitting animal carcasses according to claim 11, wherein the splitting tool holder includes a slide and a motion driver, at least one of a front carcass supporting device and a back carcass supporting device being slidingly carried by the splitting tool holder, along a to and fro direction.

16. A machine for splitting animal carcasses according to claim 11, further comprising operation programming means being programmed either for a complete splitting of the carcass in two carcass halves or for a partial splitting of the American type.

17. A machine for splitting animal carcasses according to claim 11, further comprising a programmable controller automatically causing the driver to move the splitting tool to account for wear of the splitting tool.

18. A machine for splitting animal carcasses according to claim 11, wherein the machine is entirely positioned on one side of the overhead animal carcass support.

19. A machine for splitting animal carcasses according to claim 11, wherein the machine includes two assemblies positioned on either side of the overhead animal carcass support;
wherein a first of the two assemblies includes the main carriage, the splitting tool holder, the splitting tool and a front carcass supporting device; and
wherein a second of the two assemblies includes a back carcass supporting device.

20. A machine for splitting animal carcasses according to claim 11, further comprising a first assembly including a first column supporting the main carriage, the splitting tool holder, the splitting tool and a front carcass supporting device, and a second assembly including a second column supporting a back carcass supporting device.

21. A machine for splitting animal carcasses according to claim 20, wherein the first column and the second column form a single and unitary package assembly.

22. A machine for splitting animal carcasses according to claim 11, further comprising a programmable controller;
the controller operably moving the splitting tool to an initial splitting position desired;
the carcass to be processed being moved to the initial splitting position through the combined implementation, on either side of the carcass, of a back carcass supporting device and a front carcass supporting device, said combined implementation being based on an action/reaction effect between the air pressures in the chambers of jacks of the back supporting device and the front supporting device.

23. A machine for splitting animal carcasses according to claim 11, wherein the splitting tool is partly retracted to allow for a partial splitting of the American type in order to leave an unsplit strip of skin at the back and the bottom of the carcass (American cut) while a front carcass supporting device slides toward the side where the back carcass supporting device is positioned.

24. A carcass splitting machine comprising:
a carcass splitting tool;
an upstanding column;
a carriage operably moving the splitting tool up and down the column; and
an actuator operably moving the splitting tool between in-out retracted and extended positions relative to the column;
the splitting tool being additionally movable to compensate for wear.

25. A machine of claim 24, further comprising:
at least one front roller movable between retracted and extended positions; and
at least one back roller movable between retracted and extended positions;
the rollers contacting opposite portions of the carcass when in their extended positions.

26. A machine of claim 25, further comprising:
an upstanding back column located on an opposite side of a carcass than the splitting tool; and
a back carriage movably coupling the back roller to the back column, the back roller being movable relative to the back column in both substantially vertical and substantially horizontal directions.

27. A machine of claim 24, further comprising a programmable controller connected to the actuator and automatically causing the splitting tool to be additionally extended to compensate for wear.

28. A machine of claim 24, further comprising a programmable controller connected to the actuator and causing the splitting tool to be additionally extended to compensate for wear based on a manual operator input.

29. A machine of claim 24, wherein the splitting tool translates in a horizontal direction of carcass movement with a carcass during splitting of the carcass.

30. A machine of claim 24, wherein the splitting tool is a circular saw blade which is additionally extended toward a carcass to compensate for a reduced outside diameter of the saw blade due to its wear cutting repeated splitting operations.
